(19) United States
(12) Patent Application Publication
(10) Pub. No.: US 2005/0102892 A1
(43) Pub. Date: May 19, 2005

(54) Tree shelter

(76) Inventor: Adrianne Jacqueline Jones, North Wales (GB)

Correspondence Address: HARRISON & EGBERT, 412 MAIN STREET, 7TH FLOOR, HOUSTON, TX, 77002, US

(21) Appl. No.: 10/500,830

(22) PCT Filed: Jan. 23, 2003
(86) PCT No.: PCT/GB03/00306

(30) Foreign Application Priority Data
Jan. 23, 2002 (GB) 0201403.3

(51) Int. Cl. A01G 13/02

(52) U.S. Cl. 47/29.7

(57) ABSTRACT

A tree shelter includes a biodegradable fibrous mat coated with a degradable resin and adapted to be formed into a roll which can enclose at least the lower part of a plant. The mat is preferably non-woven and its structure is preferably impregnated with a second degradable resin which degrades at a different, preferably faster, rate to that of the first degradable resin under the same environmental conditions. Such a shelter has the advantage that once the first resin has substantially degraded over a predetermined time period to expose the mat to the weather, the second degradable resin commences a faster degradation to cause the mat to decompose rapidly into a loose fibrous state and ultimately form a beneficial mulch around the stem or trunk at the base of the plant.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to a tree shelter and, in particular, to a degradable tree shelter and preferably one which is fully biodegradable.

### BACKGROUND OF THE INVENTION

The term “tree shelter” when used herein and in the claims should be understand as meaning a shelter suitable for use with any form of plant, either woody or herbaceous, and not as only suitable for use with trees.

When young trees and shrubs are first planted, it is desirable to provide them with support and protection from damage caused by adverse weather conditions, such as high winds, ground erosion and animals. Typically, this is done by means of a tree shelter which encloses at least the lower part of the tree or shrub in a tubular support.

Conventional tree shelters are typically cast from photo-degradable plastics materials that are designed to degrade within three to four years. It has been found, however, that such supports do not fully degrade within the time frame but disintegrate gradually between three and ten years into separate pieces so that the unsightly remains of the supports can still be present around the tree or shrub for some considerable time. As much tree and shrub planting is carried out for landscaping purposes, having disintegrating supports still visible some years after planting is undesirable and in order to remedy the situation it is common practice to remove the supports after a sufficient period of time has elapsed to enable the trees or shrubs have become established. However, apart from the effort involved, an additional problem is created because the remains of the tree shelters removed from such sites have to be disposed of. Typically, they end up as refuse in landfill sites where they are buried. However, as they are only photo-degradable, once buried degradation will take longer and they therefore can become an environmental nuisance.

The object of the present invention is to overcome the aforementioned disadvantages of conventional tree shelters, and to provide a tree shelter which is designed to degrade into a loose fibrous state over a predetermined time span.

### BRIEF SUMMARY OF THE INVENTION

According to a first aspect of the present invention there is provided a tree shelter comprising a biodegradable fibrous mat covered with a degradable resin and adapted to be formed into a roll which can enclose at least the lower part of a plant.

It will be appreciated that because the core of the shelter comprises a biodegradable fibrous mat, once the exterior coating of resin starts to degrade, the fibrous core is exposed to environmental conditions and therefore also starts to degrade. Unlike conventional photo-degradable tree shelters, which tend to disintegrate into large pieces, the fibrous nature of the tree shelter of the present invention means that ultimately it will decompose back into a loose fibrous state that will absorb moisture and form a beneficial mulch around the base of the plant, unlike the large pieces of conventional photo-degradable shelters, which serve no additional purpose and tend to litter the planting area and be carried away by the wind to form a nuisance elsewhere.

The degradable resin is preferably also fully biodegradable but can be subject to other forms of degradation in addition to or instead of biodegradation.

There are three main routes to degradation, as follows.
1. Biodegradation, wherein the material is broken down by the action of bacteria, such as yeasts, and moulds. Such degradation is slow in the atmosphere but more active when the material is in direct contact with soil.
2. Photo-degradation, as mentioned above, wherein ultra-violet light acts at a molecular level to breakdown the molecules of the material into smaller molecules, thus causing the material to disintegrate.
3. Moisture degradation, wherein a continual softening and hardening of a material by the action of water absorption, either above or below ground level, causes the material to disintegrate.

Preferably, the degradable resin comprises an exterior coating over the side surfaces of the fibrous mat. The resin stiffens the mat and also slows its own biodegradation, which may otherwise occur too quickly. Hence, the quantity of resin used is a factor to be taken into account when determining a required life for the shelter. For example, one for use in viniculture may only be required to last for two years prior to biodegradation. In contrast, in slow-growing forest plantations, it may be necessary to use shelters which will last for up to five years to give the sapling trees sufficient time to establish themselves before degradation.

Such time spans can be substantially predetermined by choosing an appropriate resin and the thickness of the coating.

The shelter may comprise a laminate structure made from two outer sheets of resin which are bonded to and enclose the fibrous mat. Alternatively, the side surfaces of the fibrous mat can be with the resin by rolling or painting the resin on to the mat.

It will also be appreciated that the number of layers of fibres in a non-woven mat and the thickness of the yarn and looseness of the weave in a woven mat will affect the overall thickness of the fibrous mat. This, in turn, will affect the length of time that the tree shelter will take to biodegrade.

Hence, tree shelters can be manufactured in accordance with requirements.

It is expected that in most cases, the shelter will have an overall thickness that is in the range 1 mm to 4 mm but that in some cases could be as much as 10 mm, of which up to 2 mm on each side would comprise the thickness of the outer resin coating.

It will be appreciated that ideally, as soon as the resin coating has degraded to the extent that the fibrous mat has become substantially exposed to environmental conditions, the shelter will thereafter disintegrate very quickly into a loose fibrous state that can form a mulch around the base of the plant, as indicated above. The fibres, then being in contact with the soil, will themselves commence a more rapid biodegradation.

Hence, to this end, preferably the structure of the fibrous mat is impregnated with a second degradable resin which degrades at a different rate to that of the first degradable resin under the same environmental conditions.

Advantageously, the second resin encapsulates the fibres of the mat and degrades at a rate which is significantly faster than that of the first resin. For example, the first resin may take up to five years to degrade whereas the second resin may be designed to degrade within six months. In such an arrangement, the degradation of the second resin enhances and speeds up the degradation of the fibrous mat, which does not need to be as rigid a structure as in embodiments of shelter where only a first resin is used. As before, preferably both the first and the second resins are fully biodegradable.

The fibrous mat may comprise either a woven or a non-woven mat. Preferably, however, and in particular when it is desired that the mat disintegrates quickly after the first resin has degraded, the mat is non-woven. Such a mat may comprises a plurality of cross-lapped layers of fibres that may be cross-linked, for example by needle-punching.

The fibrous mat may be manufactured from many different types of fibrous material but preferably is substantially made from flax fibres. Other biodegradable materials that could be use instead or in addition are hemp, mineralized straw and appropriately treated grass waste.

Suitable, fully biodegradable resins for use in the shelter comprise those made of polyvinyl alcohol; those made of biodegradable copolyester such as poly (tetramethylene adipate-co-terephthalate); and resins made from cashew nut shells. Such resins can all be used as the exterior covering for the fibrous mat, namely as the first resin, and there life-span before degradation may be altered by addition of a UV-stabilizer. The first two resins, without the addition of any UV-stabilizer, are also suitable for use as the second resin. All of these resins biodegrade completely into non-toxic residues.

The resin made substantially from polyvinyl alcohol is preferably a mixture comprising between 20% and 95% polyvinyl alcohol, up to 70% calcium carbonate and between 5% and 30% propanetriol. Such a resin can be bought commercially, for example from the PVAXX Group. The copolyester resin can also be bought commercially under the trade mark EASTAR from Eastman Chemical Company. Cashew nut shell resins can be bought from Palmer (UK) Limited and comprise natural renewable liquid extracted from cashew nut shells and comprising a mixture of around 90% anacardic acid and 10% cardol. Typically they are cross-linked with hexamine to form a solid thermosetting plastic.

Preferably also, the tree shelter comprises at least one stake. Again, the stake is preferably made from a bio-degradable material such as wood or cane. It may also be possible to make the stake from a mixture of the same fibres as the fibrous mat and a stiffening, degradable resin, possibly also the same as one of the resins used in the manufactured of the shelter. In this case an appropriate resin/fibre ratio would be used to provide a rigid structure that would last, in use, for at least as long as the predetermined life of the shelter.

Advantageously, the fibrous mat can be impregnated with a slow-release fertilizer and/or a weed suppressing preparation. These impregnations are preferably designed to become active after biodegradation of the shelter. Hence, even after the tree shelter has degraded it may still have a useful purpose for the formerly enclosed plant.

According to a second aspect of the present invention there is provided a method of making a tree shelter comprising the steps of: manufacturing a fibrous mat from biodegradable fibres; covering the sides of the mat with a biodegradable resin; and cutting the resin-covered mat into a shape which is adapted to be formed into a self-supporting roll that can enclose at least the lower part of a plant.

Preferably, the fibrous mat is manufactured by carding biodegradable fibres into a loose layer; stacking a plurality of the carded fibre layers over the top of one another; and needle-punching the stacked layers to cross-link them to form the mat. The layers of fibres may be stacked in any conventional manner, such as by being cross-lapped or air-blown.

Advantageously, the method comprises the additional steps of mixing a second degradable resin in powdered or granular form with the biodegradable fibres prior to manufacture of the mat and of curing the second resin by heating the mat after manufacture and prior to covering by the first degradable resin.

The sides of the mat may be covered with the degradable first resin by laying pre-formed sheets of the resin over the opposing sides of the mat and laminating the resin sheets and the mat together by the application of heat and pressure.

Alternatively, the first resin may be extruded in a sheet form directly over each side of the mat and then cured.

If the first resin is in a liquid form, it may be rolled or brushed directly over each side of the mat and then cured.

Preferably, the resin-covered mat is cut into a substantially rectangular panel. In a first embodiment, at least one projecting tab is formed along one edge of the panel which can be inserted into a slit cut close to an opposing edge of the panel to enable the rectangular panel to be formed into a self-supporting roll. Alternatively, in a second embodiment a series of slits are cut along two opposing edges of the panel through which a stake can be inserted after the panel has been formed into a roll in order to retain the shelter in a rolled state.

In both of the above embodiments, a stake or another stake may also be secured to the panel either by being pushed through appropriately spaced slits cut into the body of the mat or by stitching. It is also possible to secure the stake by means of metal ties or rings which are simply, pushed through the mat but these have the disadvantage of not being biodegradable and therefore unlikely to be used in practice.

Preferably also, prior to covering the sides of the mat with the resin, the mat is impregnated with a slow-release fertilizer and/or a weed suppressing preparation. These impregnations may be in a powdered or granular form and mixed with the fibres or scattered between the fibre layers during manufacture of the mat.

It will be appreciated that the tree shelter can be made in any appropriate size. Typically, they will be made to provide, in use, an inner diameter in the range 40 mm to 250 mm, inclusive, and an height in the range 0.6 m to 1.8 m, inclusive. Such shelters are suitable for use with a wide range of plants, trees and shrubs, including herbaceous plants and climbers.

### BRIEF DESCRIPTION OF THE SEVERAL VIEWS OF THE DRAWINGS

The present invention will now be described by way of example with reference to the accompanying drawings, in which:

FIG. 1 is a plan view of an unrolled tree shelter according to the present invention with a portion of an outer resin covering removed revealing an inner fibrous mat;

FIG. 1a is a cross-sectional view through a portion of the shelter along the line X-X in FIG. 1;

FIG. 2 is a perspective view of the shelter shown in FIG. 1 when formed into a roll;

FIG. 3 is a perspective view of a second embodiment of tree shelter according to the present invention; and

FIG. 4 is a schematic view of the shelter shown in FIG. 2 when in use.

### DETAILED DESCRIPTION OF THE INVENTION

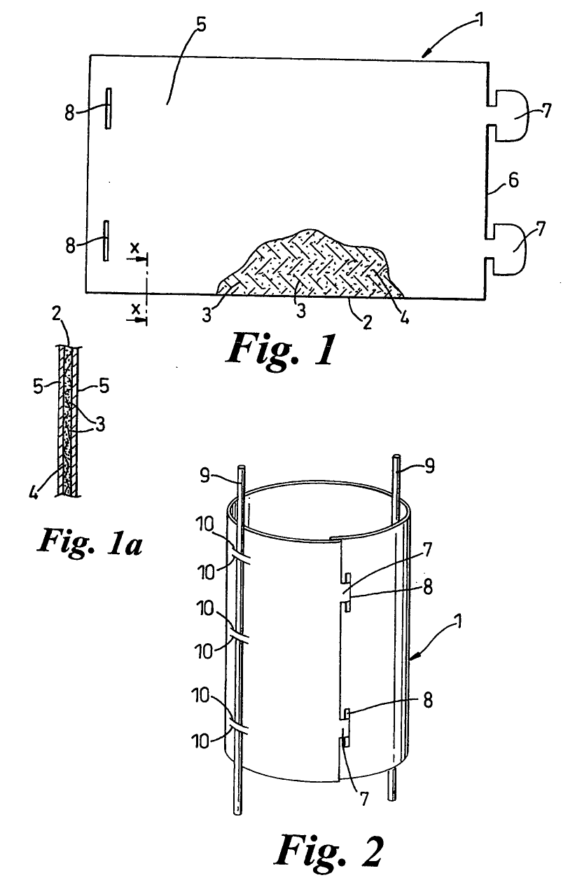

FIG. 1 shows a tree shelter 1 comprising a fibrous mat 2 and which has preferably been manufactured as described above using two resins which degrade at difference rates.

The mat 2 is preferably made from raw flax fibres 3 which after being de-baled are mixed with one of the degradable resins 4 that has been produced in a powdered or granular form. It is expected that typically the mixture will comprise around 50% flax fibre and 50% resin but the exact quantities can be varied in order that the finished mat is likely to degrade within a desired time span. As indicated above, this resin may comprise polyvinyl alcohol, poly (tetramethylene adipate-co-terephthalate), or a similar resin. If any further additive are to be included within the mat 2, such as a slow-release fertilizer this is also preferably incorporated into the mixture at this stage in a granular or powdered form.

After mixing, the fibrous mixture is carded into loose layers that are then stacked to form a plurality of carded layers, preferably by either being cross-lapped or being air-blown. These stacked layers are then cross-linked by needle-punching to form the mat 2.

The resin 4 mixed into the fibrous mat 2 is then cured by heating the mat so that the resin 4 melts and encapsulates the fibres 3.

The other resin 5 is then applied to each side of the mat 3. This resin may comprise a cashew nut oil resin, as described above, which is applied in a liquid form by brushing or rolling to form a thermosetting exterior coating over both sides of the mat 2. These resin coatings 5 are then cured by again heating the mat 2 and allowing it to cool.

The final, laminated structure of the shelter 1 is shown in FIG. 1a wherein it can be seen that the mat 2 forms a inner layer and comprises a mixture of the fibres 3 and the resin 4 whereas the second resin 5 forms two outer layers which completely cover the mat 2.

This finished laminate structure is then cut into substantially rectangular panels 6 of a predetermined size in accordance with the size of the plant or tree to be protected.

In a first embodiment as shown in FIGS. 1 and 2, along one of the shorter edges of the panel 6 are formed two spaced, projecting tabs 7 and along the opposing edge are cut two slits 8 that correspond to the positions of the tabs 7 so that when the panel 6 is rolled up, each tab 7 can be inserted into a corresponding slit 8 to retain the panel 4 in a rolled state, as shown in FIG. 2. The tabs 7 have been shaped for this purpose by being made spoon-shaped, as shown in FIG. 1, in known fashion so that once inserted into the slits 8 they cannot easily be pulled out of position.

Alternatively, the tabs 7 could be made arrow-shaped.

The rolled-up panel 6 shown in FIG. 2 has been provided with two stakes 9. These stakes 9 may be fastened to the panel 6 by weaving the stakes 9 through slits 10 cut appropriately in the panel 4 for this purpose. Both of the stakes 9 are used to anchor the shelter 1 to ground and one of them may also be secured to the plant being protected, as an additional support for it. Preferably, therefore, at least one of the stakes 9 is positioned so that it will be enclosed by the rolled-up panel.

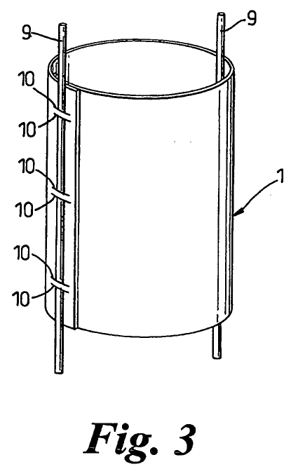

In a second embodiment, as shown in FIG. 3, the mat is cut into a rectangular panel that is provided with a plurality of slits similar to the slits 10 along two opposing edges. When the panel is rolled up, a stake 9 can be woven through the slits 10 in the overlapping portion of the panel to retain the shelter 1 in a rolled-up state before being pushed into the ground as an anchor. No additional fixing mechanism to retain the shelter in a rolled state is therefore required in this embodiment.

It will be appreciated that in use, the tree shelter 1 of the invention is stored and transported in panel form and only assembled into a rolled-state on site. This facilitates the storage and transportation of the shelter 1 as compared to conventional shelters which are usually manufactured in a tubular form.

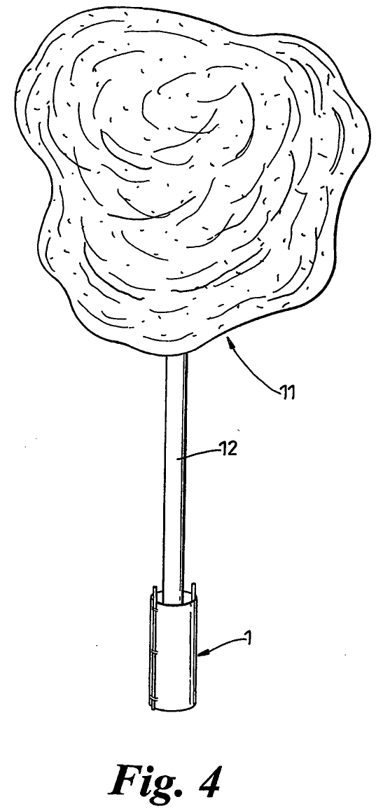

In use, as shown schematically in FIG. 4, the shelter 1 is staked to the ground close to a tree or plant 11, such as a sapling, and then rolled up around the stem or trunk 12 of the plant and secured in this position using either the tabs 7 and slits 8 or one of the stakes 9 as shown in FIG. 3. The plant 11 may also be secured to one of the stakes 9, other than that used to retain the shelter 1 is a rolled state, prior to enclosure by the shelter 1. Alternatively, if the plant is not to be physically attached to the shelter 1, the shelter 1 may be folded around the stem or trunk 12 of the plant 10 and secured by means of the tabs 7 and slits 8 or the stake 9 prior to being staked into the ground.

1. A tree shelter comprising:
a biodegradable fibrous mat covered with a degradable resin and adapted to be formed into a roll which can enclose at least a lower part of a plant.

2. A tree shelter as claimed in claim 1, wherein the fibrous mat comprises a woven mat.

3. A tree shelter as claimed in claim 1, wherein the fibrous mat is non-woven and comprises a plurality of layers of fibers.

4. A tree shelter as claimed in claim 3, wherein the degradable resin comprises an exterior coating over side surfaces of the fibrous mat.

5. A tree shelter as claimed in claim 4, wherein the fibrous mat is further comprised of a second degradable resin impregnated therein, said second degradable resin being degradable at a different rate to that of the first degradable resin under same environmental conditions.

6. A tree shelter as claimed in claim 5, wherein the second resin encapsulates fibers of the mat.

7. A tree shelter as claimed in claim 5, wherein rate of degradation of the first resin is longer than the rate of degradation of the second resin.

8. A tree shelter as claimed in claim 5, wherein the first and second resins are both biodegradable.

9. A tree shelter as claimed in claim 3, wherein the layers of fibers are cross-linked.

10. A tree shelter as claimed in claim 1, wherein the mat is comprised of at least one of or a mixture of flax fibers, hemp, mineralized straw and treated grass waste.

11. A tree shelter as claimed in claim 1, further comprising: a laminate structure made from two outer sheets of the first degradable resin which are bonded to and enclose the fibrous mat.

12. A tree shelter as claimed in claim 1, wherein at least one of the degradable resins substantially comprises polyvinyl alcohol.

13. A tree shelter as claimed in claim 12, wherein said at least one resin is a mixture comprising between 20% and 95% polyvinyl alcohol, up to 70% calcium carbonate and between 5% and 30% propanetriol.

14. A tree shelter as claimed in claim 1, wherein at least one of the degradable resins comprises a copolyester resin made from poly (tetramethylene adipate-co-terephthalate).

15. A tree shelter as claimed in claim 1, wherein at least one of the degradable resins comprises a cashew nut shell resin.

16. A tree shelters as claimed in claim 5, wherein the first degradable resin comprising an exterior coating over the side surfaces of the fibrous mat is comprised of a cashew nut shell resin, and the second degradable resin is comprised of polyvinyl alcohol or poly (tetramethylene adipate-co-terephthalate).

17. A tree shelter as claimed in claim 1, further comprising at least one biodegradable stake comprised of fibers same as the fibrous mat and a degradable resin.

18. A tree shelter as claimed in claim 1, further comprising a stake which is passed through slits provided in the fibrous mat to retain a rolled state when in use.

19. A tree shelter as claimed in claim 1, wherein the fibrous mat is impregnated with a slow-release fertilizer and/or a weed suppressing preparation.

20. The use of a tree shelter as claimed in claim 1.

21. A method of making a tree shelter comprising the steps of:
manufacturing a fibrous mat from biodegradable fibers;
covering sides of the mat with a degradable resin; and
cutting the resin-covered mat into a panel which is adapted to be formed into a self-supporting roll that can enclose at least the lower part of a plant.

22. A method as claimed in claim 21, wherein the step of manufacturing the fibrous mat comprises:
carding biodegradable fibers into a loose layer;
stacking a plurality of the carded fibre layers over one another; and
needle-punching the stacked layers to cross-link them to form the mat.

23. A method as claimed in claim 21, further comprising the steps of:
mixing a second degradable resin in powdered or granular form with the biodegradable fibres prior to manufacture of the mat and
curing the second resin by heating the mat after manufacture and prior to covering by the first degradable resin.

24. A method as claimed in claim 23, wherein the first and second resins are both biodegradable and the rate of degradation of the first resin is longer than the rate of degradation of the second resin.

25. A method as claimed in claim 21, wherein the fibrous mat comprises a woven mat made from biodegradable yarn.

26. A method as claimed in claim 21, further comprising the step of:
impregnating, prior to covering the sides of the mat with the first resin, the mat with a slow-release fertilizer and/or a weed suppressing preparation.

27. A method as claimed in claim 21, further comprising the steps of:
covering the sides of the mat with the degradable first resin by laying pre-formed sheets of the resin over the opposing sides of the mat and
laminating the resin sheet and the mat together by the application of heat and pressure.

28. A method as claimed in claim 21, further comprising:
extruding the first resin in a sheet form directly over each side of the mat; and
curing the first resin.

29. A method as claimed in claim 21, further comprising:
rolling or brushing the first resin in a liquid form directly over each side of the mat; and
curing the first resin.

30. A method as claimed in claim 21, further comprising:
cutting the resin-covered mat into a substantially rectangular panel along one edge of which is formed at least one projecting tab that can be inserted into a slit cut close to an opposing edge of the panel to enable the rectangular panel to be formed into a self-supporting roll.

31. A method as claimed in claim 21, further comprising: securing at least one stake to the panel.

32. A method as claimed in claim 21, further comprising:
cutting the resin-covered mat into a substantially rectangular panel along two opposing edges of which a series of slits are cut and through which a stake can be inserted after the panel has been formed into a roll in order to retain the shelter in a rolled state.
